(19) United States
(12) Patent Application Publication
(10) Pub. No.: US 2015/0096935 A1
(43) Pub. Date: Apr. 9, 2015

(54) NANOCARBON IMMOBILIZED MEMBRANES

(71) Applicants: Somenath Mitra, Bridgewater, NJ (US); Sagar Roy, Newark, NJ (US); Madhulina Bhadra, Newark, NJ (US)

(72) Inventors: Somenath Mitra, Bridgewater, NJ (US); Sagar Roy, Newark, NJ (US); Madhulina Bhadra, Newark, NJ (US)

(21) Appl. No.: 14/506,995

(22) Filed: Oct. 6, 2014

Related U.S. Application Data
(60) Provisional application No. 61/886,771, filed on Oct. 4, 2013.

(51) Int. Cl. B01D 69/14; B01D 69/08; C02F 1/44; B01D 61/36; B01D 69/12; B01D 71/02; B01D 69/06

(52) U.S. Cl. CPC B01D 69/148; B01D 71/021; B01D 69/08; B01D 69/06; B01D 61/364; B01D 69/12; C02F 1/447; C02F 2103/08
USPC 210/500.23; 210/500.27; 210/500.25; 210/500.37; 210/500.38; 210/500.33

(57) ABSTRACT

Membranes including functionalized carbon nanotubes, nanodiamonds and/or graphene oxide immobilized in or on the membranes are disclosed. The membranes including the immobilized nanocarbons increase interactions with water vapor to improve desalination efficiency in membrane distillation. The membranes may be deployed in all modes of membrane distillation such as air gap membrane distillation, direct contact membrane distillation, vacuum membrane distillation and other separations.

### CROSS-REFERENCE TO RELATED APPLICATIONS

This application claims the benefit of U.S. Provisional Application No. 61/886,771 filed Oct. 4, 2013, the entirety of which is incorporated herein by reference.

### FIELD OF THE INVENTION

The present invention relates to the field of membrane distillation and in particular to nanocarbon enhanced membranes.

### BACKGROUND OF THE INVENTION

As the shortage of clean water looms in the horizon, there is much interest in developing novel, cost effective desalination technology. Current methodologies include thermal, chemical and reverse osmosis. Membrane distillation (MD) has emerged as an alternative to address some of the issues related to the current technologies.

### SUMMARY OF THE INVENTION

In accordance with one or more embodiments, novel nanocarbons (NCs) and functionalized nanocarbons are disclosed which may be incorporated into membranes. Such membranes are referred to herein as nanocarbon immobilized membranes (NCIMs). Functionalization of the NCs may serve to alter the chemical properties thereof, leading to specific interactions with solutes, or just a change in hydrophilicity. For purposes of this disclosure, NCIMs may include and refer to NCs of all types, including carbon nanotubes (CNTs, referred to as CNIMs when immobilized in a membrane), diamond and graphene nanocarbon materials. NCIMs as disclosed herein may be employed for example to increase desalination efficiency in membrane distillation (MD).

In membrane distillation a hot salt solution such as sea or brackish water is passed through (or across) a hydrophobic membrane which acts as a physical barrier separating the warm solution from a cooler permeate. The permeation is driven by a vapor pressure gradient resulting from the temperature difference and solution composition gradients across the membrane. Typically, membrane distillation is carried out at 60-90° C., which is significantly lower than conventional distillation. Therefore membrane distillation can employ only low temperature heat sources such as waste heat from industrial processes and solar energy.

There are various types of membrane distillation, including direct contact MD (DCMD), air gap MD (AGMD), sweeping gas MD (SGMD), and vacuum MD (VMD). These terms refer to the permeate side of the membrane. In all cases, the feed is in direct contact with the membrane. In DCMD, both sides of the membrane contact a liquid phase. The liquid on the permeate side is used as the condensing medium for the vapors. In AGMD the condensed permeate is not in direct contact with the membrane and in SGMD a sweep gas is used to remove the water vapor.

NCIMs as disclosed herein can be applied in different forms of MD.

In accordance with one or more embodiments, membranes are disclosed which include a functionalized nanocarbon immobilized on or in a pore of the membrane. The functionalized nanocarbon may be for example a carbon nanotube, a nanodiamond, or graphene oxide.

In accordance with a some embodiments, membranes are disclosed which may include a nanocarbon immobilized on or in the pores of the membrane, wherein the nanocarbon is a carbon nanotube including a functional group such as but not limited to a carboxylic acid, a polymer, a metal, a metal oxide, an amine, an amide, a nitro, a hydroxyl, polyaminobenzene sulfonic acid, propyl amine, alkyl amine, octadecylamine, and/or sulphonic acid. In one embodiment the functional group is carboxylic acid or octadecylamine.

Membranes disclosed herein may be hollow fiber membranes, flat membranes, etc. In one embodiment the membrane is a bilayer membrane. In one such embodiment, the membrane includes a first layer which includes a carbon nanotube having one or more functional groups such as but not limited to a carboxylic acid, a polymer, a metal, a metal oxide, an amine, an amide, a nitro, a hydroxyl, polyaminobenzene sulfonic acid, propyl amine, alkyl amine, octadecylamine, and/or sulphonic acid, wherein the carbon nanotube is immobilized in a pore of a membrane, and a second layer. In another embodiment, the second layer may include an immobilized carbon nanotube having one or more functional groups such as but not limited to a carboxylic acid, a polymer, a metal, a metal oxide, an amine, an amide, a nitro, a hydroxyl, polyaminobenzene sulfonic acid, propyl amine, alkyl amine, octadecylamine, and/or sulphonic acid.

In another embodiment, a membrane is disclosed which includes a nanodiamond immobilized on or in the pores of the membrane. The nanodiamond may or may not include a functional group. In one embodiment the nanodiamond may include one or more functional groups such as but not limited to a carboxylic acid, a polymer, a metal, a metal oxide, an amine, an amide, a nitro, a hydroxyl, polyaminobenzene sulfonic acid, propyl amine, alkyl amine, octadecylamine, and/or sulphonic acid.

In still a further embodiment, a membrane is disclosed which includes graphene oxide immobilized on or in the pores of the membrane. The graphene oxide may or may not include a functional group. In one embodiment the graphene oxide may include one or more functional groups such as but not limited to a carboxylic acid, a polymer, a metal, a metal oxide, an amine, an amide, a nitro, a hydroxyl, polyaminobenzene sulfonic acid, propyl amine, alkyl amine, octadecylamine, and/or sulphonic acid.

In yet further embodiments, membranes are disclosed which may include at least two layers, wherein first layer includes a membrane having a nanocarbon immobilized on or in the pores of the membrane, wherein the immobilized nanocarbon is a carbon nanotube having one or more functional groups such as but not limited to a carboxylic acid, a polymer, a metal, a metal oxide, an amine, an amide, a nitro, a hydroxyl, polyaminobenzene sulfonic acid, propyl amine, alkyl amine, octadecylamine, and/or sulphonic acid; or the immobilized nanocarbon is a nanodiamond, or graphene oxide. In some embodiments, wherein the immobilized nanocarbon is a nanodiamond or graphene oxide, such nanocarbon may include one or more functional groups such as but not limited to a carboxylic acid, a polymer, a metal, a metal oxide, an amine, an amide, a nitro, a hydroxyl, polyaminobenzene sulfonic acid, propyl amine, alkyl amine, octadecylamine, and/or sulphonic acid. The second layer may include a membrane having a nanocarbon immobilized on or in the pores of the membrane, wherein the immobilized nanocarbon is a carbon nanotube having one or more functional groups such as but not limited to a carboxylic acid, a polymer, a metal, a metal oxide, an amine, an amide, a nitro, a hydroxyl, polyaminobenzene sulfonic acid, propyl amine, alkyl amine, octadecylamine, and/or sulphonic acid; or the immobilized nanocarbon is a nanodiamond, or graphene oxide. In other embodiments, wherein the immobilized nanocarbon is a nanodiamond or graphene oxide, such nanocarbon may include one or more functional groups such as but not limited to a carboxylic acid, a polymer, a metal, a metal oxide, an amine, an amide, a nitro, a hydroxyl, polyaminobenzene sulfonic acid, propyl amine, alkyl amine, octadecylamine, and/or sulphonic acid.

As noted, the membranes disclosed herein may be employed in membrane distillation apparatus of all types, and may be used in other, non-distillation applications as well. In some embodiments, membrane distillation apparatus including the disclosed membranes are desalination apparatus.

### BRIEF DESCRIPTION OF THE DRAWINGS

So that those having ordinary skill in the art will have a better understanding of how to make and use the disclosed systems and methods, reference is made to the accompanying figures wherein:

FIG. 1(a) is a schematic diagram of a SGMD experimental system in accordance with one or more embodiments of the presently disclosed subject matter;

FIG. 1(b) is a schematic diagram of a DCMD experimental system in accordance with one or more embodiments of the presently disclosed subject matter;

FIGS. 2(a)-(i) are scanning electron micrographic images of an unmodified polypropylene (PP) membrane (FIG. 2(a)); a PTFE active layer (FIG. 2(b)); a CNIM-f (FIG. 2(c)); a CNIM-f after 90 days of operation (FIG. 2(d)); PTFE-CNTs (FIG. 2(e); PP-DNDs (FIG. 2(f)); PTFE-graphene (FIG. 2(g)); DND crystal (FIG. 2(h)); and graphene flakes (FIG. 2(i)) in accordance with one or more embodiments of the presently disclosed subject matter;

FIG. 3(a) is a graphical depiction of thermo gravitational analysis of unmodified membrane and CNIM-f in accordance with one or more embodiments of the presently disclosed subject matter;

FIG. 3(b) is a graphical depiction of differential scanning calorimetry of unmodified membrane, CNIM, and CNIM-f in accordance with one or more embodiments of the presently disclosed subject matter;

FIGS. 4(a)-(c) are graphical depictions, for unmodified membrane, CNIM, and CNIM-f, of the effect of temperature on permeate flux at a feed flow rate of 20 ml min⁻¹ (FIG. 4(a)); effect of flow rate on permeate flux at 90° C. (FIG. 4(b)); and the effect of feed concentration on permeate flux at a feed flow rate of 20 ml min-1, 90° C. (FIG. 4(c)) in accordance with one or more embodiments of the presently disclosed subject matter;

FIG. 5 is a graphical depiction of the effect of feed concentration on mass transfer coefficient at a feed flow rate of 20 ml min⁻¹, 90° C. for unmodified membrane, CNIM, and CNIM-f in accordance with one or more embodiments of the presently disclosed subject matter;

FIG. 6 is a graphical depiction of an operational period stability study of CNIM, CNIM-f membranes in accordance with one or more embodiments of the presently disclosed subject matter;

FIGS. 7(a)-(c) are graphical depictions, for an unmodified membrane and CNIM-COOH, of the effect of flow rate on permeate flux (FIG. 7(a)); the effect of temperature on permeate flux at 110 ml min⁻¹ (FIG. 7(b)); and the effect of feed concentration on permeate flux (FIG. 7(c)) in accordance with one or more embodiments of the presently disclosed subject matter;

FIG. 8 is a graphical depiction of thermo gravitational analysis of unmodified PP membrane and DNDIM in accordance with one or more embodiments of the presently disclosed subject matter;

FIGS. 9(a)-(c) are graphical depictions, for unmodified PP and DNDIM, of the effect of temperature on permeate flux at feed flow rate 10 mL min⁻¹ (FIG. 9(a)); the effect of flow rate on permeate flux at temperature 90° C. (FIG. 9(b)); and the effect of feed concentration on permeate flux at a feed flow rate of 10 mL min⁻¹, 90° C. (FIG. 9(c)) in accordance with one or more embodiments of the presently disclosed subject matter;

FIG. 10 is a graphical depiction of flux as a function of time in accordance with one or more embodiments of the presently disclosed subject matter;

FIG. 11(a) is a graphical depiction of the effect of temperature on permeate flux for PTFE (unmodified) and GOIM (graphene oxide immobilized membrane) in accordance with one or more embodiments of the presently disclosed subject matter;

FIG. 11(b) is a graphical depiction of the effect of feed flow rate on water vapor flux for an unmodified membrane and GOIM in accordance with one or more embodiments of the presently disclosed subject matter;

FIG. 12 is a graphical depiction of an operational stability test in accordance with one or more embodiments of the presently disclosed subject matter;

FIGS. 13(a)-(d) are scanning electron micrographic images of an unmodified PTFE membrane top surface (FIG. 13(a)); a CNIM-ODA membrane top surface (FIG. 13(b)); an unmodified membrane bottom surface (FIG. 13(c)); and a CNIM-COOH membrane bottom surface (FIG. 13(d)) in accordance with one or more embodiments of the presently disclosed subject matter;

FIG. 14 is a graphical depiction of water vapor flux as a function of feed temperature for in accordance with one or more embodiments of the presently disclosed subject matter; and

FIG. 15 is a graphical depiction of a mechanism of action on NCIM-f in accordance with one or more embodiments of the presently disclosed subject matter.

### DETAILED DESCRIPTION OF THE INVENTION

The following is a detailed description of the invention provided to aid those skilled in the art in practicing the present invention. Those of ordinary skill in the art may make modifications and variations in the embodiments described herein without departing from the spirit or scope of the present invention. Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. All publications, patent applications, patents, figures and other references mentioned herein are expressly incorporated by reference in their entirety.

Novel nanocarbon immobilized membranes (NCIMs) are disclosed herein.

Membranes which may be employed in connection with the novel NCIM may be any suitable membranes depending on the application of interest. For example, the membrane may be made from organic or inorganic material including but not limited to metal, ceramic, homogeneous films such as polymers, heterogeneous solids such as polymeric mixes, mixed glasses, etc. Suitable polymeric membranes include cellulose acetate, nitrocellulose, cellulose esters, polysulfone (PS), polyether sulfone (PES), polyacrylonitrile (PAN), polyamide, polyimide, polyethylene (PE), polypropylene (PP), polytetrafluoroethylene (PTFE), polvinylidene fluoride (PVDF), polyvinyl chloride (PVC), etc.

Membranes are disclosed which include a functionalized nanocarbon immobilized on or in a pore of the membrane. The functionalized nanocarbon may be for example a carbon nanotube, a nanodiamond, or graphene oxide.

In accordance with one embodiment nanocarbon immobilized membranes are disclosed which include functionalized carbon nanotubes (CN or CNTs) immobilized on or in the pores of the membrane. Such NCIMs may be referred to CNIM-f.

Any suitable carbon nanotube may be used in the fabrication of the subject CNIM-f structures. For example, single wall (SW) CNTs, multi wall (MW) CNTs, thin wall (TW) CNTs, etc. may be employed, all of which are commercially available from Cheap Tubes of Brattleboro, Vt. Suitable CNT sizes are in the range of from 2 to 100 nm. Preferably the CNT sizes are in the range of from 10 to 30 nm.

Functional groups which may be used to functionalize CNTs include but are not limited to carboxylic acid, a polymer, a metal, a metal oxide, an amine, an amide, a nitro, a hydroxyl, polyaminobenzene sulfonic acid, propyl amine, alkyl amine, octadecylamine, and/or sulphonic acid, etc. Functionalized CNTs are commercially available for example from Cheap Tubes and/or Sigma Aldrich. of St. Louis, Mo.

In another embodiment, nanocarbon immobilized membranes are disclosed which include nanodiamond material immobilized in the membrane pores. Nanodiamond particles have hydrophilic negative surface chemistry which is surprisingly useful when immobilized in membrane pores. Such NCIMs are referred to herein as DNDIMs. Nanodiamond material may be obtained commercially from Carbodeon of Vantaa, Finland. Suitable nanodiamond particle sizes are in the range of from 4 to 10 nm. Preferably the nanodiamond particle sizes are in the range of from 5 to 80 nm. In other embodiments, nanodiamonds are functionalized with functional groups such as but not limited to carboxylic acid, a polymer, a metal, a metal oxide, an amine, an amide, a nitro, a hydroxyl, polyaminobenzene sulfonic acid, propyl amine, alkyl amine, octadecylamine, and/or sulphonic acid.

In another embodiment, NCIMs are disclosed which include graphene oxide material immobilized in the membrane pores. Graphene oxide is in the form of sheets with hydroxyl, carboxyl, and epoxide groups. Single or double-layer graphene oxide may be employed in the membrane. Such NCIMs are referred to herein as GOIMs. Graphene oxide may be obtained commercially from Cheap Tubes. Suitable graphene particle sizes are in the range of from 5 to 80 nm. Preferably the graphene oxide particle sizes are in the range of from 10 to 30 nm.

In other embodiments, graphene oxide is functionalized with functional groups such as but not limited to carboxylic acid, a polymer, a metal, a metal oxide, an amine, an amide, a nitro, a hydroxyl, polyaminobenzene sulfonic acid, propyl amine, alkyl amine, octadecylamine, and/or sulphonic acid.

In accordance with a further embodiment, bilayer fabricated functionalized nanocarbon membranes are disclosed. As above, such bilayer NCIMs may employ any suitable membrane depending on the application. For example, in a membrane for a DCMD in a desalination application the membrane may be a PTFE composite membrane. In some embodiments, the bilayer NCIMs disclosed herein may include one or more CNIM-f, DNDIM and or GOIM on a first layer and one or more CNIM-f, DNDIM and or GOIM on a second layer. The DNDM and/or GOIMs may be functionalized.

In other embodiments, the bilayer membranes may include a first side, such as a feed-facing side in a membrane used for membrane distillation, which includes only one species of NCIM, e.g., functionalized carbon nanotubes such as CMT-COOH, and a second side, such as a permeate side, which includes e.g., functionalized carbon nanotubes such as CNT-ODA.

In some embodiments, membranes as disclosed herein are useful in connection with membrane distillation apparatus and applications of any kind. In certain embodiments, the disclosed NCIMs may be employed in membrane distillation desalination apparatus and/or systems.

The following non-limiting examples and experiments serve to further illustrate the embodiments disclosed herein.

### Experiments and Examples

### Materials and Methods

Experiments were conducted using both hollow fiber and flat membranes. Membrane modules for MD were constructed in a shell and tube format using ¼inch polypropylene (PP) tubing. Ten 16.6 cm long hollow fiber strands were used in each module. Each module contained approximately 12.50 cm² of effective membrane contact area (based on internal surface). The ends were then sealed with epoxy to prevent leakage into the shell side. MD was also carried out using flat polypropylene (PP) membranes having 14.514 cm² of effective area.

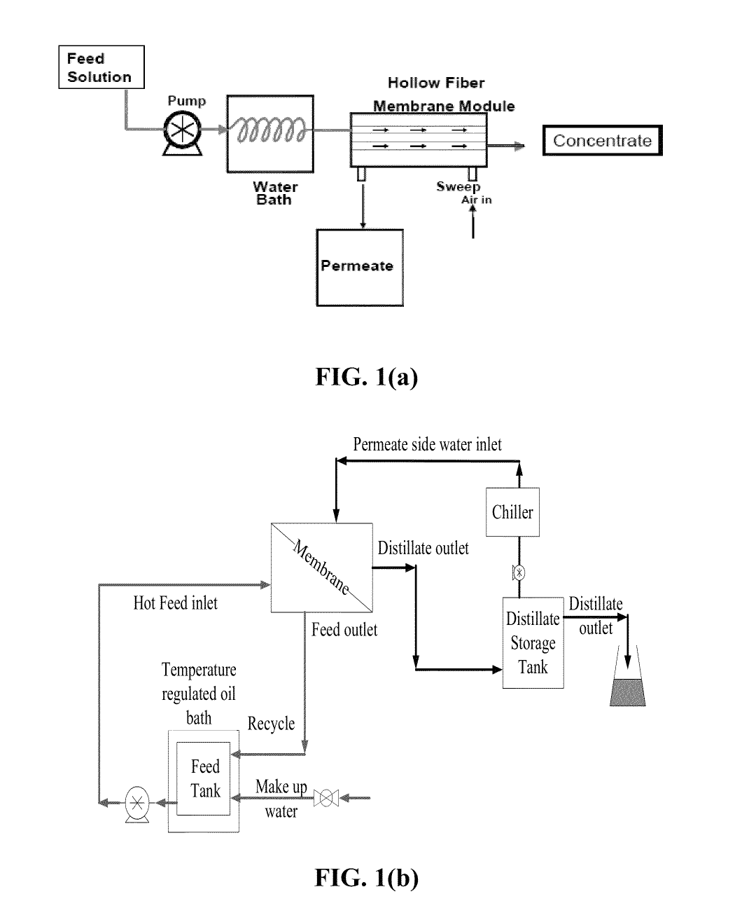

Two experimental setups were employed in various phases of testing as described below. Now referring to FIG. 1(a) an experimental system in sweep gas MD mode is shown. The feed used in these experiments contained 3.4 wt % NaCl solutions (Sigma Aldrich). The feed was pumped through the membrane module using a Master flex 7519-10 peristaltic pump. The preheated hot feed solution traveled through a heat exchanger which was used to maintain the desired temperature throughout experiments. Dry air was passed into the shell side and the permeate was collected in a trap. Air flow was maintained at 1 liter min⁻¹. The ionic strength of the original solution, the permeate and the concentrate were measured using a Jenway Electrode Conductivity Meter 4310.

The other experimental system, for DCMD, is shown in FIG. 1(b). The membrane module used for the DCMD set up was a flat, disk-shaped module with a gasket diameter of 4.3 cm and an effective membrane area of 14.514 cm². The feed used in these experiments contained 15000 mg/L NaCl solution (Sigma Aldrich) and deionized water was used as the permeate. Both hot and cold sides were circulated through the membrane module using a peristaltic pump (Cole Parmer, model 7518-60). The preheated hot feed solution traveled through a heat exchanger, which was used to maintain the desired temperature through out the experiment and was fed to one side of the DCMD cell module. The hot feed was recycled to the feed tank and the permeate was obtained in the distillate tank. The distillate tank included a liquid level controller to avoid overflow of water due to continuous condensation of the water vapor in the distillate side of stream across the membrane. Inlet and outlet temperatures of the feed and distillate were monitored continuously throughout the experiment. Viton and different PVC tubings and connectors (Cole Parmer) were used to make connections in the experimental set up. The ionic strength of the original feed solution and permeate were measured using a Jenway Electrode Conductivity Meter 4310. Each experiment under any given parameter was run for 2 hours. Each experiment was repeated three times for reproducibility.

CNTs, nanodiamond and graphene were used as nanocarbons for the fabrication of NCIMs and functionalized NCIMs (NCIM-f).

The synthesis of carboxylated CNTs (MWCNT-COOH) was carried out as follows. Pristine MWCNT was purchased from Cheap Tubes, Inc., Brattleboro, Vt., USA. CNT carboxylation was carried out in a Microwave Accelerated Reaction system (CEM Mars) fitted with internal temperature and pressure controls. 300 mg of original MWCNTs was added to the reaction chamber together with 25 ml 1:1 conc H₂SO₄ and HNO₃. The reaction was carried out at 120° C. for 40 min. After cooling, the product was vacuum filtered using a Teflon membrane with pore size 0.45 μm, and the solid was dried in a vacuum oven at 70° C. for 5 hours. This led to the formation of carboxylated CNTs (MWCNT-COOH).

Carboxylated CNTs were used as the starting material for the synthesis of octadecyl amine derivative. A pre-weighed amount of MWCNT-COOH was mixed with thionyl chloride and DMF. The reaction vessel was subjected to microwave radiation around 70° C. for 20 min. The final suspension was filtered and washed with THF until the filtrate turned from brown color to clear. The filtrate solids were dried in a vacuum oven at room temperature for 12 h to obtain base material for the synthesis of organic dispersible MWCNTs. For the octadecyl amidation reaction, 20 ml of N,N-dimethylformamide (DMF) was used as the solvent and 15-20 mg of octadecyl amine (C₁₈H₃₉N) was added. The reaction was carried out for 15-20 min. Once cooled, the mixture was filtered, washed with DMF and finally with anhydrous tetrahydrofuran (THF) and vacuum dried at room temperature for a few hours. The functionalized CNTs were characterized by FTIR which confirmed the presence of carboxyl groups. The results are not presented here for brevity.

NCIMs with pure carbon nanotubes (referred to as CNIM, i.e., carbon nanotube immobilized membranes) and functionalized carbon nanotubes (CNIM-f) were prepared using various polypropylene, PTFE and PVDF based membranes. For example, in some embodiments NCIMs were prepared using Celgard type X30-240 (Celgard, LLC, and Charlotte, N.C., USA) hollow fiber with pore size (0.04 μm) as the starting material. For the preparation of NCIM and NCIM-f, each of 10 mg of NC or NC-f were dispersed in a solution containing 0.1 mg of polyvinylidene fluoride in 15 ml of acetone by sonicating for three hours. The PVDF-nanotube dispersion was coated, filtered or in some cases was forced under controlled vacuum into the bore of the hollow fiber membrane. The PVDF served as glue that held the CNTs in place within the membrane. The membrane was flushed with acetone to remove excess nanotubes. The original membrane was sonicated in PVDF solution in acetone without the CNTs, and this served as the control. The morphology of the CNIMs and CNIM-f were studied using scanning electron microscopy (SEM, Model LEO 1530), and thermal gravitational analysis (TGA) was performed using a Perkin Elmer Pyris 7 TGA instrument to study the thermal stability of the membrane. Differential scanning calorimetry (DSC) was also carried out using a Universal V4.5A TA instrument to observe the alterations in thermal properties.

Characterization of the Prepared Membranes

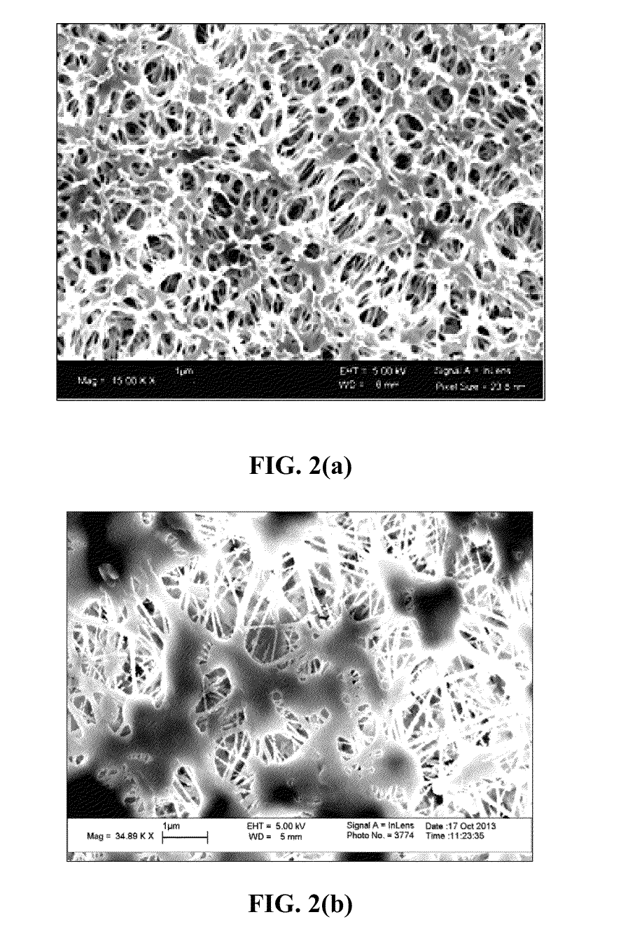

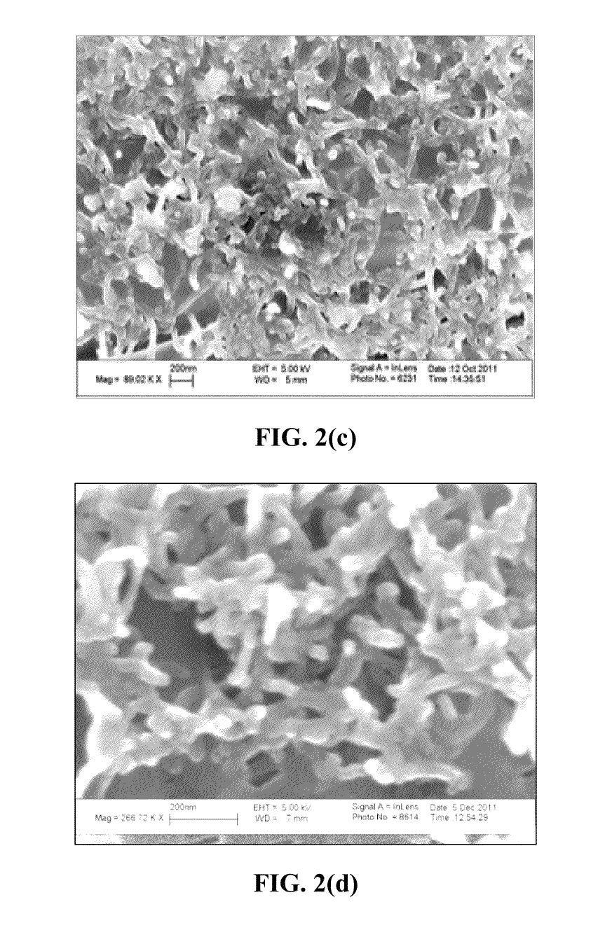

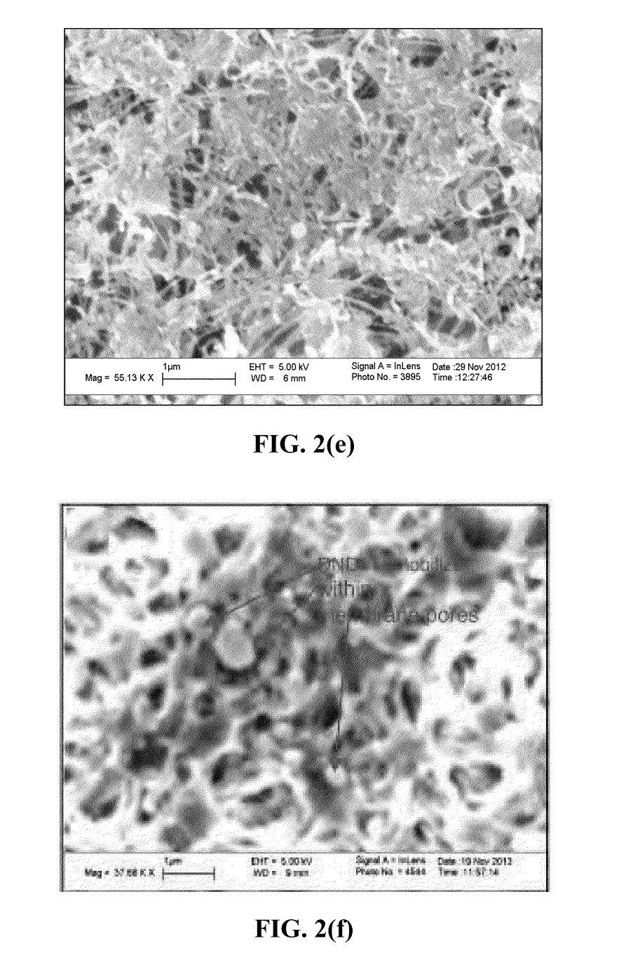

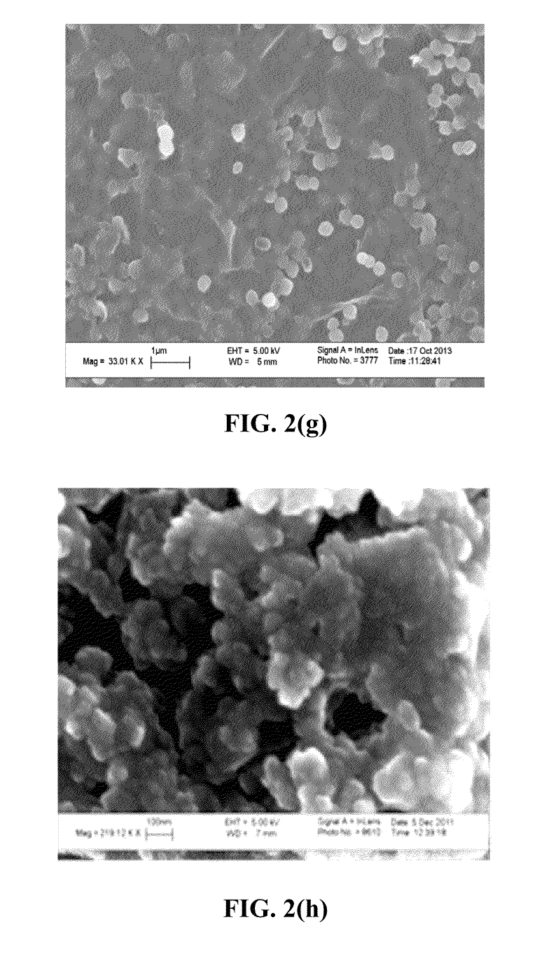

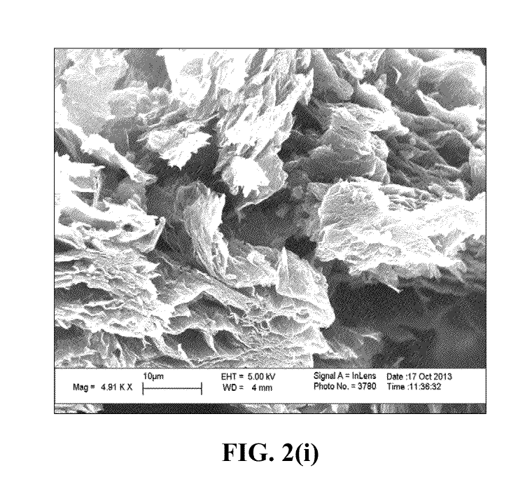

Scanning electron micrographs of the original PP membrane, a PTFE active layer, and CNIM-COOH (CNIM-f) are shown in FIGS. 2(a), 2(b) and 2(c), respectively. The incorporation of the CNT-COOH is clearly evident in FIG. 2(c). Additionally, with reference to FIG. 2(d) the CNT-COOH is shown intact within the membrane after 90 days of continuous usage.

For comparison, SEM images of NCIM with CNTs incorporated on PTFE, nanodiamonds on PP, and graphene on PTFE are presented in FIGS. 2(e), 2(f) and 2(g), respectively. FIGS. 2(h) and 2(i) show SEM images of DND crystal and graphene flakes, respectively.

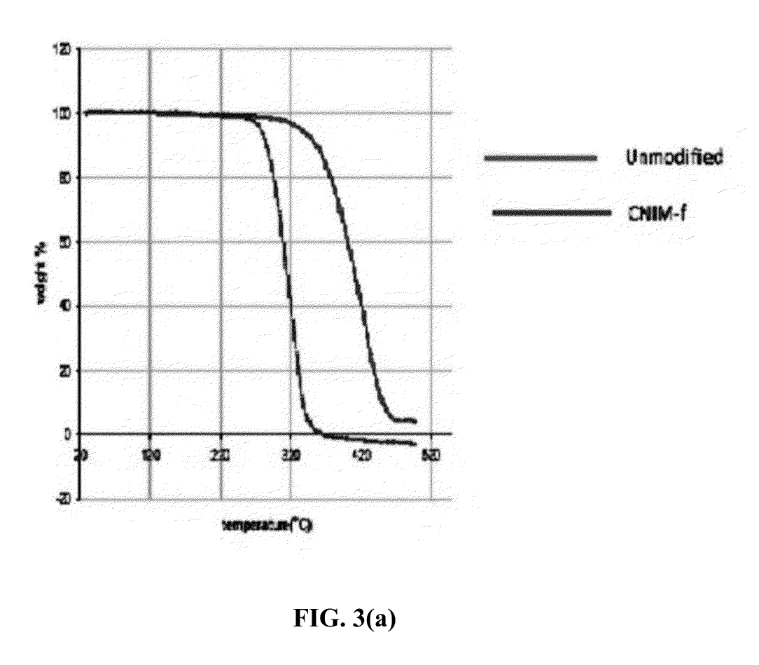

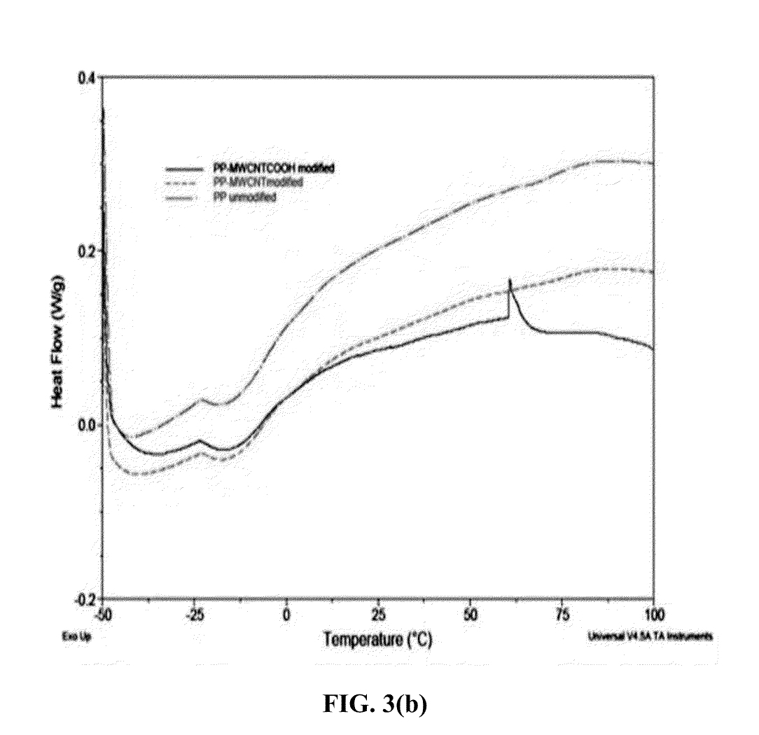

Now referring to FIG. 3(a), thermogravitational analysis of unmodified membrane and CNIM-f (with CNT-COOH) is shown. The thermal degradation of the unmodified polypropylene membrane started at around 260° C. However, in line with previous observations, the presence of CNT-COOH increased the degradation temperature by 40° C. This implies that the CNT-COOH was highly stable and enhanced the thermal stability of the membrane. This was also true for nanodiamond and graphene immobilized membranes in accordance with other embodiments of the presently disclosed subject matter.

FIG. 3(b) shows differential scanning calorimetry of the unmodified membrane, CNIM (CNT) and CNIM-f (CNT-COOH).

Desalination Using NCIM

NCIMs and NCIM-fs were tested for MD. The water vapor flux, J_{w}, across the membrane can be expressed as:

$${J}_{w} = \frac{{w}_{p}}{tA} \qquad ( 1 )$$

where, wₚ is the total mass of permeate, t is the permeate collection time and A is the membrane surface area.

Also, J_{w} can be denoted as:

J_{w}=k(C_{f}−Cₚ) (2)

where, k is the mass transfer coefficient, C_{f} and Cₚ is the water vapor concentration in feed and permeate side. Usually Cₚ is close to zero, since we utilize dry air as sweep gas. So overall mass transfer coefficient was calculated as

$$k = \frac{Jw}{{C}_{f}} . \qquad ( 3 )$$

Functionalized Carbon Nanotube Immobilized NCIM for Membrane Distillation

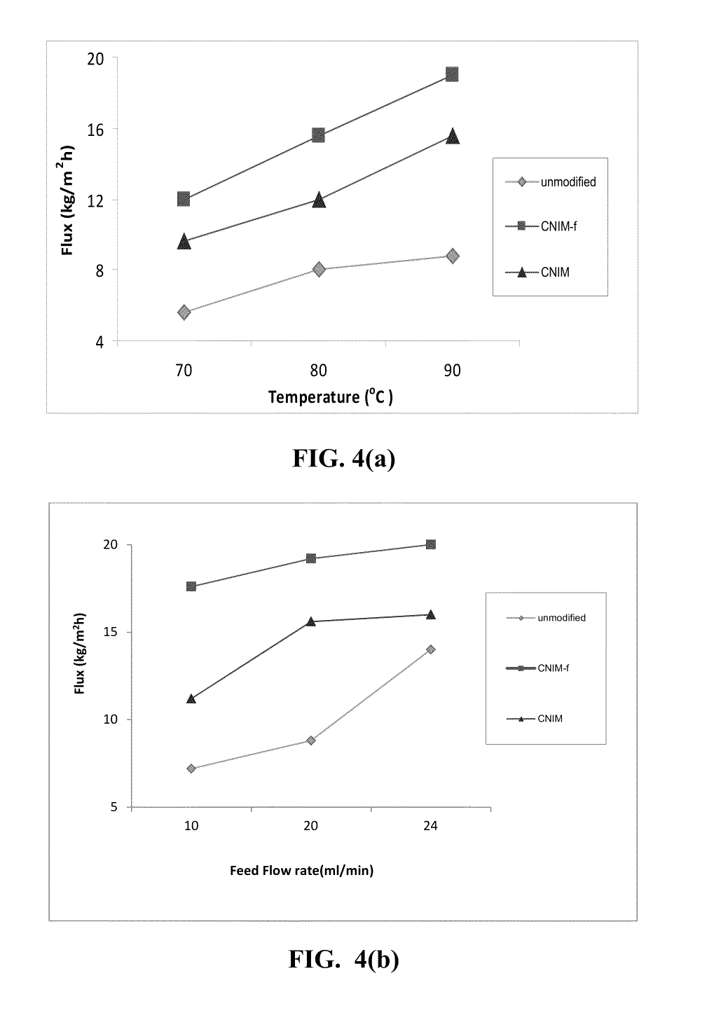

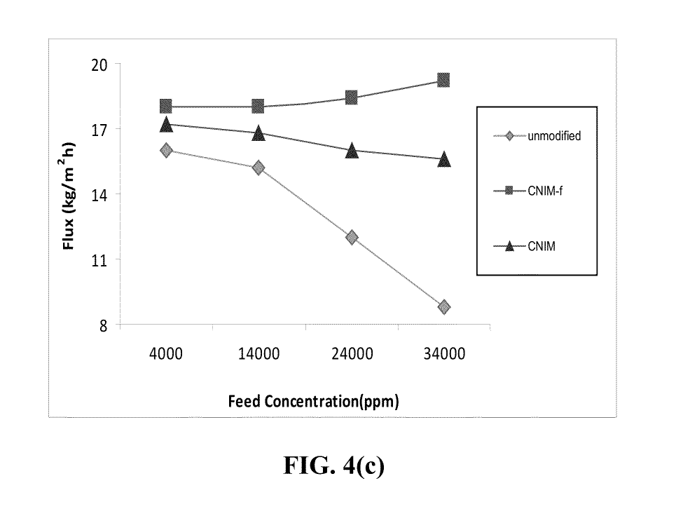

With reference to FIG. 4(a), increasing temperature increased flux for all three membrane types. Flux at 70° C. using either CNIM or CNIM-f was higher than what was obtained by the plain membrane. The permeate flux was the highest for the CNIM-f membrane.

With reference to FIG. 4(b), desalination as a function of flow rate is shown. Increasing flow rate increased permeate flux. Compared to the unmodified membrane, CNIM and CNIM-f demonstrated higher flux at all flow rates. At elevated flow rate, there was reduced boundary layer and adsorption-desorption processes were faster.

Now referring to FIG. 4(c), the effect of varying of feed concentration on permeate flux is shown for all three membrane types. It is well known that concentration polarization is more important at higher feed concentration. At higher feed concentration, a more significant boundary layer develops next to the membrane interface and this reduces driving force of mass transfer. This leads to the decrease in permeate flux in the case of unmodified membrane modules. On the other hand, in the CNIM, and CNIM-f, the flux remained unchanged. The presence of CNTs increased the surface roughness that prevented the formation of stable boundary layers. As observed from FIG. 4(c), for CNIM-f, the flux remained constant with increasing salt concentration, reaching up to 19.2 kg/m² h.

Various CNT loadings in mg/cm² of membrane area were also investigated. A range of from 0.001 mg to 0.01 mg of MWCNT per centimeter square, preferably, an optimum value of 0.005 mg of MWCNT per centimeter square was required to enhance the overall percent removal and flux. It was estimated that significantly higher MWCNT amount would block the pores of the hydrophobic membrane, thereby reducing flux and removal efficiency.

Additionally, as observed from Table 1, the mass transfer coefficient enhancements were found to be significantly higher for CNIM-f as compared to the unmodified membrane. Enhancement for CNIM ranged between 50%-77%. However, for CNIM-f, enhancement ranged from 95%-116%.

TABLE 1
Mass transfer coefficient and enhancement % at various feed
temperature at 20 ml/min.

| | Mass Transfer Coefficient × 10⁷ | | | | |
|---|---|---|---|---|---|
| | (kg/m² · s · Pa) | | | Enhancement (%) | |
| Temp (° C.) | Unmodified | NCIM | NCIM-f | NCIM | NCIM-f |
| 70 | 0.499 | 0.856 | 1.07 | 72 | 114 |
| 80 | 0.469 | 0.704 | 0.915 | 50 | 95 |
| 90 | 0.349 | 0.618 | 0.753 | 77 | 116 |

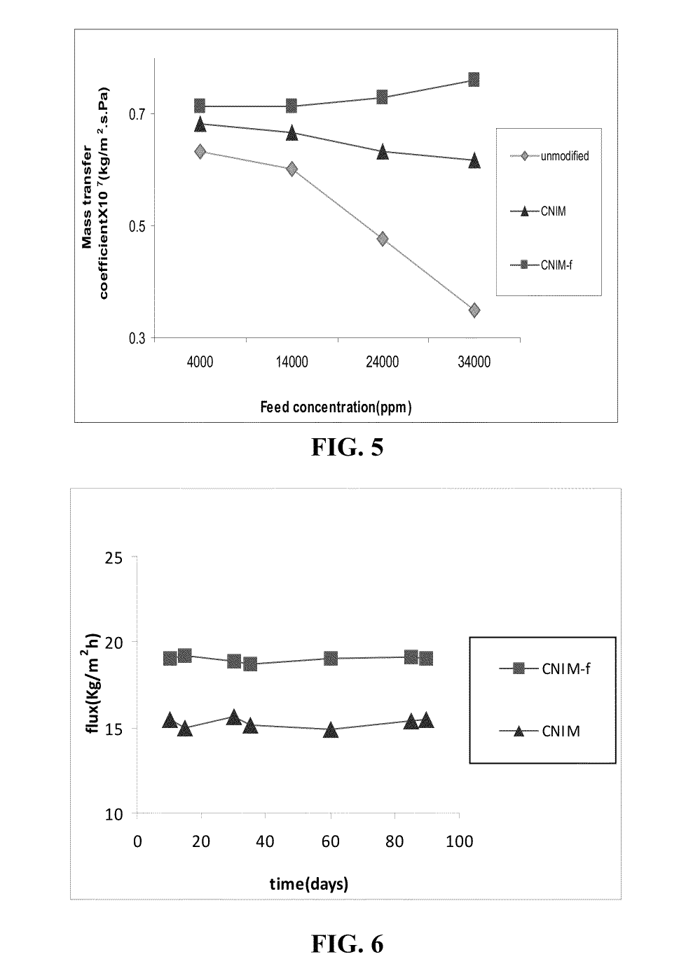

Table 2 indicates the effect of feed flow rate on mass transfer coefficient. The overall mass transfer coefficient was enhanced by the presence of CNIM-f. The enhancement in mass transfer coefficient was higher at a low flow rate. At a flow rate of 10 mL/min, the mass transfer coefficient of the CNIM-f was 145% higher than the unmodified membrane, whereas for CNIM, enhancement was just 56%; but the corresponding values dropped to 27% and 59% when inlet feed flow rate was 24 ml/min. In general, the presence of the CNT-COOH led to enhanced permeability through the membrane, and the CNIM-f showed a significantly higher overall mass transfer coefficient. With reference to FIG. 5, it is important to note that whereas an increase in feed concentration decreased k for the unmodified membrane, it remained almost constant and showed negligible decrease for CNIM and CNIM-f. At 34000 mg L⁻¹, the mass transfer coefficent was more than double for CNIM-f than the unmodified membrane.

TABLE 2
Mass transfer coefficient and enhancement % at various feed
flow rate at 90° C.

| | Mass Transfer Coefficient × 10⁷ | | | | |
|---|---|---|---|---|---|
| | (kg/m² · s · Pa) | | | Enhancement (%) | |
| Flow rate (ml/min) | Unmodified | NCIM | NCIM-f | NCIM | NCIM-f |
| 10 | 0.285 | 0.444 | 0.697 | 56 | 145 |
| 20 | 0.349 | 0.618 | 0.753 | 77 | 116 |
| 24 | 0.5 | 0.634 | 0.793 | 27 | 59 |

Salt Breakthrough and Stability of the NCIM and NCIM-f:

There was no observabale salt breakthrough in any of the experiments, and the permeate showed low conductivity of 1 to 2.5 μS/cm at 20° C., implying that the water had over 99.9% purity. The stability of the membrane, especially the ability to retain the CNT coating on the surface was tested for long term operation. With reference to FIG. 6, a test was carried out for ninety days and there was no observable decrease in flux over this period of time using either CNIM or CNIM-f. The SEM images of CNIM-f after 90 days of operation (see FIG. 2(c) also did not show any visible signs of CNT erosion or damage.

Direct Contact Membrane Distillation Using NCIM

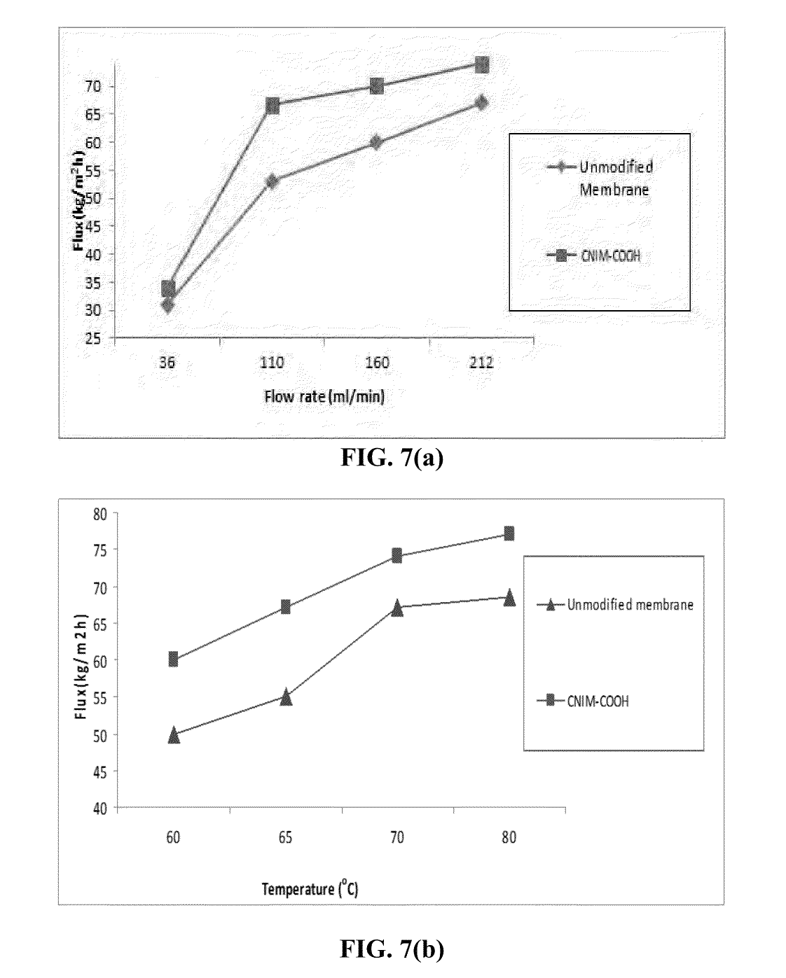

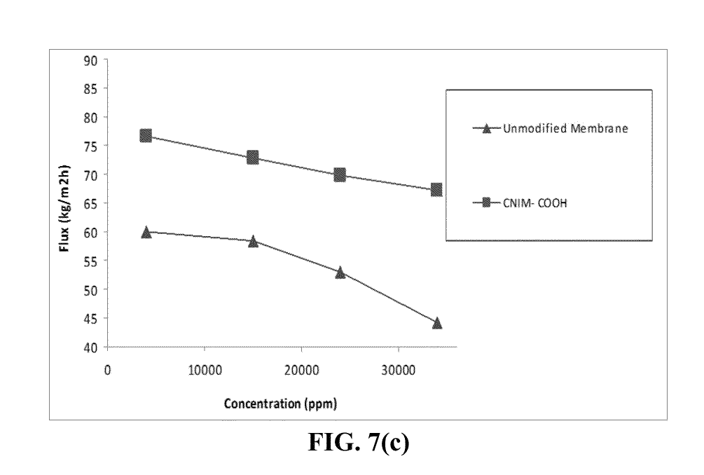

NCIMs using carbon nanotube as the nanocarbon were tested in the direct contact membrane distillation mode using the apparatus shown in FIG. 1(b). The nominal pore size of the PTFE flat membrane employed was 0.03 micron with a thickness of 35 micron. Now referring to FIG. 7(a), the effect of feed flow rate on permeate flux was measured. During the experiments, the feed side flow rate was varied from 30 ml min⁻¹ to 212 ml min⁻¹ and permeate side flow rate (110 ml min⁻¹) and permeate side temperature (T=20° C.) was maintained constant. Permeate fluxes rose as the feed velocity increased for both conventional, unmodifed PTFE membrane and the NCIM including —COOH-functionalized carbon nanotube, referred to as CNIM-f or CNIM-COOH. The CNIM-f showed the best performance at all velocities and flux reached 73 kg/m² h at a flow rate of 212 ml min⁻¹. Typically, higher velocity means high turbulence which will result in less temperature polarization and increased driving force across the membrane. Furthermore, at elevated flow rate, there was reduced boundary layer and adsorption-desorption processes were faster.

Temperature influence on membrane flux of the CNIM-f compared to the unmodified PTFE membrane was depicted at two different feed flow rates (110 ml min⁻¹ and 212 ml min⁻¹) in FIG. 7(b). The permeate fluxes of both membranes increased as the temperature rose. This could be due to the fact that temperature difference creates higher vapor pressure difference and thus the water vapor flux rises. As could be observed, maximum flux reached up to 77 kg/m² h for CNIIM-f membrane at flow rate 212 ml min⁻¹. Overall, CNIM-f showed consistently higher flux at all temperatures than unmodified PTFE. At a temperature of 65° C. and feed flow rate of 212 ml min⁻¹, CNIM-f showed a flux of 68 kg/m² h, whereas unmodified PTFE showed similar around flux at a temperature of 80° C. Thus, CNIM-f demonstrated higher flux even at lower temperatures, providing an overall energy efficient process.

FIG. 7(c) shows the effect of varying feed concentration on permeate flux. It is known that concentration polarization is more important at higher feed concentration. At higher feed concentration, a more significant boundary layer develops next to the membrane interface which reduces driving force of mass transfer. Consequently, this led to the decrease in permeate flux in the case of the unmodified membrane. On the other hand, for CNIM-f, the flux showed minimal decrease and reached a plateau. The presence of CNT-COOHs increased the surface roughness that prevented the formation of stable boundary layers as confirmed in FIG. 7(c).

Furthermore, Table 3 shows that mass transfer coefficients increased with increasing flow rate and CNIM-f series membranes have significantly higher mass transfer coefficients than the unmodified membrane within the tested velocity ranges. Interestingly, the enhancement in mass transfer coefficient was higher at a low flow rate reaching up to 40%. As observed from Table 4, varying temperature did not affect mass transfer coefficient exceedingly. Although the mass transfer coefficient is dependent on temperature, in many cases it is approximately near to constant, which was also observed in the subject systems. However, the CNIM-f showed overall higher mass transfer coefficients than the unmodified membrane at all feed temperatures. In general, the presence of the PTFE polymer within CNT-COOH dispersion led to enhanced permeability through the membrane, and the CNIM-f showed a significantly higher overall mass transfer coefficient.

TABLE 3
Mass transfer coefficient at various feed flow rate at 70° C.

Mass transfer
coefficient (kg/m² · s · Pa)

| Flow rate (ml/min) | Unmodified | CNIM-COOH |
|---|---|---|
| 36 | 4.30792E−07 | 5.23964E−07 |
| 110 | 7.36516E−07 | 1.02789E−06 |
| 160 | 8.32402E−07 | 1.08029E−06 |
| 212 | 9.31068E−07 | 1.14039E−06 |

TABLE 4
Mass transfer coefficient at various feed temperature at 212 ml/min

Mass transfer
coefficient (kg/m² · s · Pa)

| Temperature (° C.) | Unmodified | CNIM-COOH |
|---|---|---|
| 60 | 9.04873E−07 | 1.09837E−06 |
| 65 | 9.18798E−07 | 1.12844E−06 |
| 70 | 9.33055E−07 | 1.14039E−06 |
| 80 | 9.53997E−07 | 1.16377E−06 |

Nanodiamond Immobilized NCIM for Membrane Distillation

In accordance with embodiments herein nanodiamonds (DNDs) were incorporated into and immobilized within the pore structure of a membrane. Using techniques similar to those described above, a nanodiamond incorporated NCIM, referred to herein as a DNDIM, was fabricated on polypropylene (PP) hollow fiber modules. Nanodiamonds were obtained from Sigma Aldrich. The nanodiamonds had an average particle size of from 4 to 10 nm.

The nanodiamond modified membrane (DNDIM) has superior hydrophobicity as compared to the unmodified membrane module. Immobilization of only a minimal quantity of NDs in the pores of a hydrophobic membrane favorably alters the water-membrane interactions to enhance vapor permeability while preventing liquid penetration into the membrane pores thereby enhancing permeate flux in sweep gas membrane distillation process.

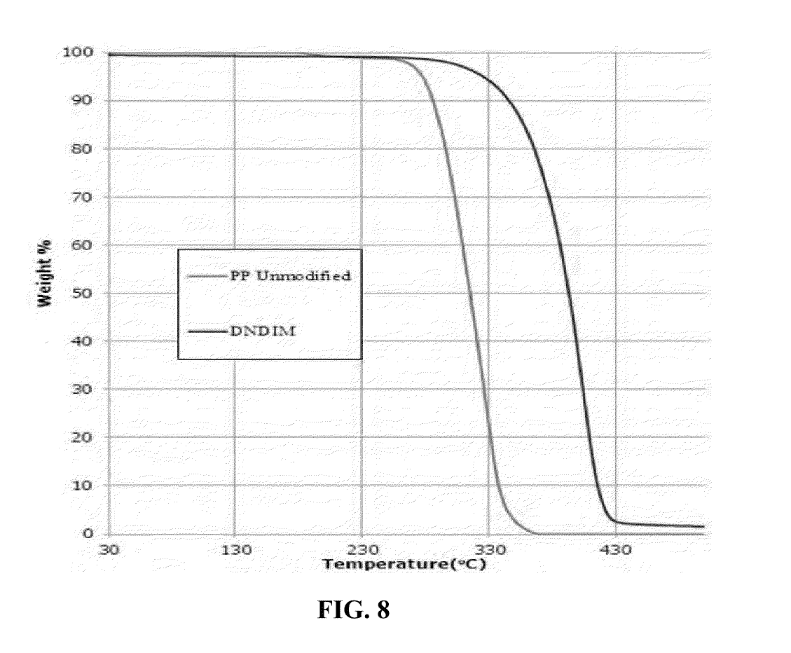

Membrane distillation experiments were carried out at different temperatures and flow rates using the experimental system presented in FIG. 1(b). DNDs utilized for fabrication of DNDIM dispersed well in PVDF-acetone solution after sonication. Scanning electron micrographs of the unmodified membrane and DNDIM are shown in FIGS. 2(a) and 2(f), respectively. As compared to the unmodified membrane, the incorporation of the DNDs in DNDIM is clearly evident, the DNDs being uniformly distributed within the membrane. Now referring to FIG. 8, thermal gravimetric analysis (TGA) was performed to determine the thermal stability of the DNDIM membrane. The TGA reflects the amount of DND was approximately 2% by weight. As observed, the thermal degradation of unmodified polypropylene membrane started at around 260° C. The presence of DNDs increased the degradation temperature by 40° C., indicating the DNDs were highly stable and enhanced the thermal stability of the membrane. Incorporation of carbon nanotubes has shown similar behavior in terms of enhancing thermal stability. K. Gethard, et al., Water desalination using carbon-nanotube enhanced membrane distillation. Appl. Mater., 3 (2011), pp. 110-114. This is an important factor for MD, where the elevated temperatures can be used for desalination. Additionally, surface chemistries of the pristine DNDs were characterized by FTIR spectroscopy and from the spectra it was confirmed that surface functional groups such as hydroxyl-carboxylic, and amines were present on the DNDs surface. See, C. Desai, et al., Microwave induced carboxylation of nanodiamonds, Diam. Relat. Mater., 34 (2013), pp. 65-69. The results are not presented here for brevity.

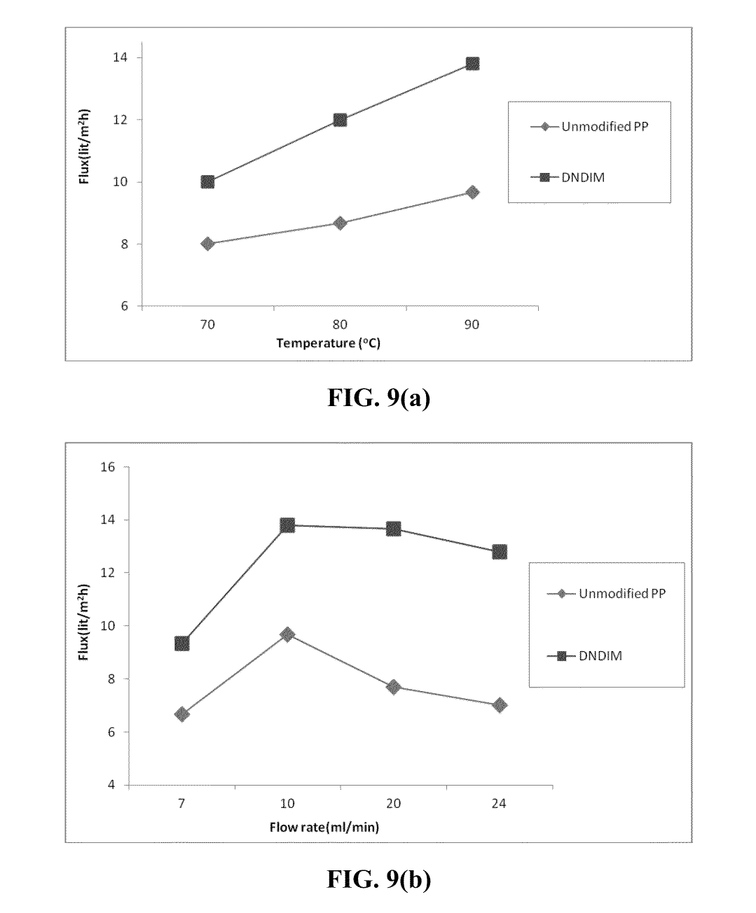

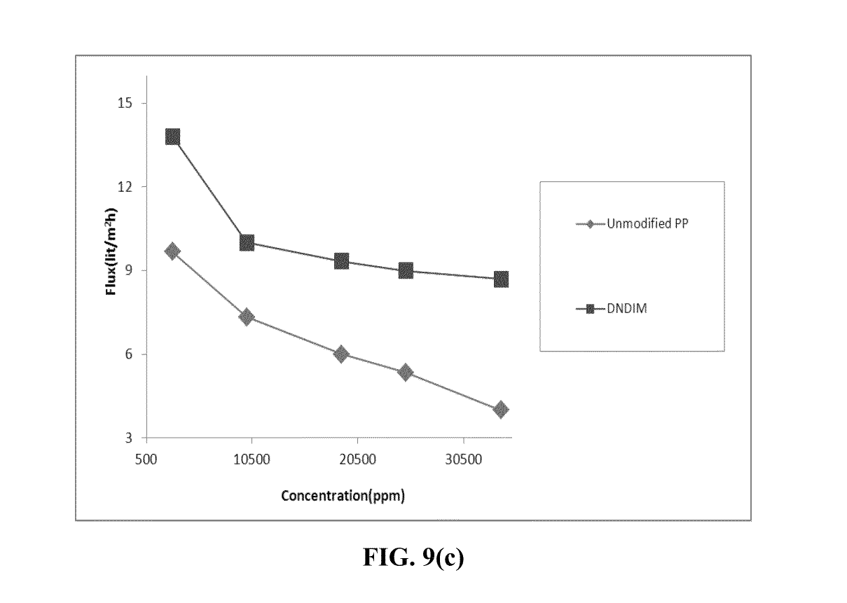

Now referring to FIG. 9(a), increasing temperature increased permeate flux for both membrane types. This was due to the fact that the increased temperature difference created higher vapor pressure difference, thus enhancing overall water vapor flux. The DNDIM membrane showed enhanced flux at all temperatures. For example at 70° C. feed temperature, the flux using DNDIM was 10 lit/m² h and was nearly the same (9.67 lit/m² h) as that accomplished at 90° C. using the conventional unmodified membrane. At 90° C., the flux using DNDIM reached as high as 13.8 lit/m² h. The incorporation of DNDs generated significantly higher vapor flux at all temperatures.

Desalination as a function of flow rate is shown in FIG. 9(b). Experiments were carried out at a feed temperature 90° C., in range of 7-24 mL min⁻¹ feed flow rates. It was seen that for both membranes the increasing the flow rate first increased the permeate flux initially which then decreased. Both membranes showed a similar trend; however, compared to the unmodified membrane, the DNDIM demonstrated higher flux at all feed flow rates. Enhancement as high as 83% was observed at an elevated flow rate of 24 mL min⁻¹ for DNDIM compared to the unmodified membrane. DNDIM consistently showed higher resistance to the lowering of vapor flux.

Typically, water vapor flux in membrane processes tend to decrease with increase in salt concentration. This is primarily due to the decrease in water activity as concentration increases. With reference to FIG. 9(c), which depicts the effect of varying of feed concentration on permeate flux, there was a substantial decrease in flux for the unmodified membrane from 9.67 lit/m² h to 4 lit/m² h. Typically, at an elevated feed concentration, a more significant boundary layer develops next to the membrane interface, which reduces driving force of mass transfer. This in turn leads to the decrease in permeate flux in case of unmodified membrane modules. On the other hand, the DNDIM did not show significant lowering of flux. This is believed to be due to the hydrophobic nature of the DNDs, which prevented the liquid phase penetration into the membrane pores. As can be seen from FIG. 9(c) for the DNDIM membrane, the flux reached as high as 13.8 lit/m² h, indicating that even at this extreme concentration, the DNDIM selectively allowed the passage of water vapor without any salt permeation.

Additionally, as observed from Tables 5 and 6, the mass transfer coefficients k were found to be significantly higher for the DNDIM as compared to the unmodified membrane. Table 5 indicates the effect of feed temperature on k. As observed, the overall k was enhanced by the presence of DNDs. For the DNDIM, k varied from 8.9×10⁻⁰⁸ to 5.5×10⁻⁰⁸ at temperature ranging from 70-90° C. A declining trend of k was found as the temperature increased. With the temperature polarization becoming greater at higher temperature, a decrease of the membrane mass transfer coefficient was found when the temperature was increased. See, J. Phattaranawik, R. Jiraratananon, Direct contact membrane distillation: effect of mass transfer on heat transfer. J. Membr. Sci., 188 (2001), pp. 137-143.

TABLE 5
Mass transfer coefficient at various temperatures at feed
flow rate of 10 ml/min.

Mass transfer
coefficient (kg/m² · s · Pa)

| Temperature (° C.) | Unmodified PP | DNDIM |
|---|---|---|
| 70 | 7.13 × E−08 | 8.92 × E−08 |
| 80 | 5.09 × E−08 | 7.04 × E−08 |
| 90 | 3.83 × E−08 | 5.47 × E−08 |

Furthermore, with reference to Table 6, as the flow rate of feed water was increased from 7 to 24 mL min⁻¹, k in the unmodified membrane increased initially from 2.64×10⁻⁰⁸ to 3.83×10⁻⁰⁸ and then stayed more or less constant. Interestingly, for the DNDIM the overall mass transfer enhancement was less affected at low flow rates but was higher at elevated flow rate. At a flow rate of 7 mL min⁻¹, the mass transfer coefficient of the DNDIM was 1.4 times higher than the unmodified membrane, but increased to 2 times at 24 mL min⁻¹. In general, the presence of the DNDs led to enhanced permeability of water vapor through the membrane, and the DNDIM showed a significantly higher overall mass transfer coefficient.

TABLE 6
Mass transfer coefficient at various feed flow rates at feed
temperature 90° C.

Mass transfer
coefficient (kg/m² · s · Pa)

| Feed flow rate (ml/min) | Unmodified PP | DNDIM |
|---|---|---|
| 7 | 2.64 × E−08 | 3.70 × E−08 |
| 10 | 3.83 × E−08 | 5.47 × E−08 |
| 20 | 3.05 × E−08 | 5.42 × E−08 |
| 24 | 2.77 × E−08 | 5.07 × E−08 |

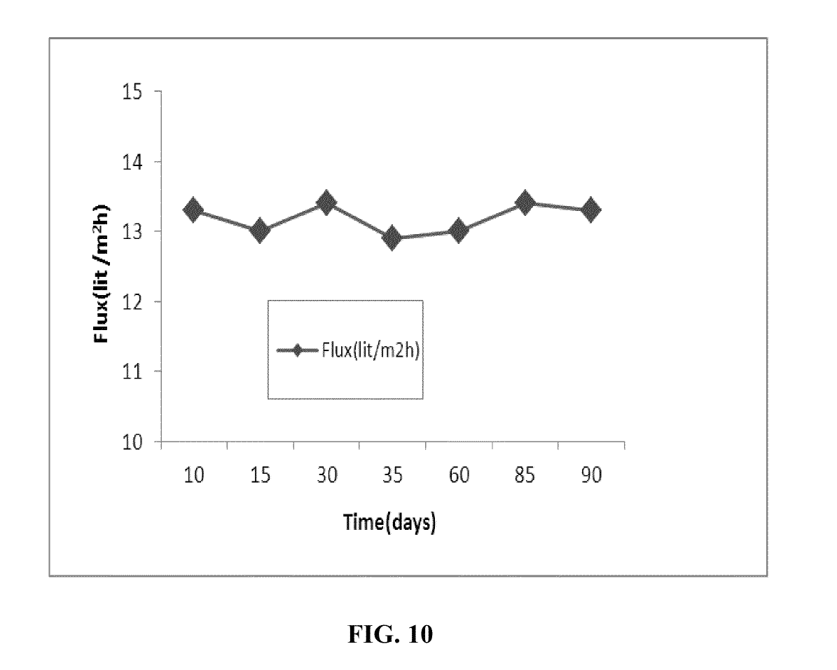

The stability of the membrane, especially the ability to retain the DND coating on the surface, was tested for long-term operation. A test was carried out for 90 days of operation and it was observed that flux did not decrease over this period of time using the DNDIM. With reference to FIG. 10, it is also notable that no salt breakthrough was observed in any of the experiments, and the permeate was pure water with significantly low conductivity (1-3.8 μS/cm at 20° C.) implying that the water had over 99.9% purity.

Direct Contact Membrane Distillation on NCIM made of Graphene Oxide:

Graphene oxide (GO) has emerged as a new interesting material because of its surface chemistry, oxygenated functional groups and excellent solubility in water, unlike graphite. See, V. Georgakilas, et al., Functionalization of Graphene: Covalent and Non-Covalent Approaches, Derivatives and Applications, Chem. Rev., 112 (2012), pp 6156-6214. The high dispersion stability of graphite oxide enables it to form a single graphene oxide layer on any substrate so that it can be applied to numerous devices such as flexible displays, transparent conducting films, and transistors for large area electronics. F. Bonaccorso, et al., Production and processing of graphene and 2d crystals. Materials Today, 15 (2012), pp. 564-589. Graphene oxide can also be converted to graphene layers with reasonable sheet resistance with several reduction routes through thermal and/or chemical treatment.

In accordance with embodiments herein GOs were immobilized within membranes.

In one embodiment, GOs were immobilized within a hydrophobic Teflon membrane to fabricate a high performance MD-based desalination membrane. A NCIM based on graphene oxide, referred to herein as GOIM, was prepared using PTFE composite membrane with a non woven fabric support and a pore size of 0.4 um. For the preparation of the GOIM, each of 10 mg of GO were dispersed in a solution containing 0.2 mg of PVDF powder (Sigma Aldrich) in 10 ml of cyclohexanone solvent (Sigma Aldrich) by sonicating for initially six hours for one day and three hours for each of two consecutive days. The PTFE-GO dispersion was then utilized for membrane fabrication. The morphology of the PTFE active layer, GOIM and GO was studied using a scanning electron microscopy (SEM, Model LEO 1530, (Carl Zeiss SMT AG Company, Oberkochen, Germany) and shown in FIGS. 2(b), 2(g) and 2(i), respectively. The experimental system employed was that shown in FIG. 1(b). The feed used in the experiments contained 5000-34000 mg/L NaCl solutions and the permeate used was deionized water. Both hot and cold sides were circulated through the module using a peristaltic pump (Cole Parmer, model 7518-60). The preheated hot feed solution traveled through a heat exchanger, which was used to maintain the desired temperature throughout the experiment and was fed to one side of the DCMD cell module. The hot feed was recycled to the feed tank and the permeate was obtained in the distillate tank. Inlet and outlet temperatures of the feed and distillate were monitored continuously throughout the experiment. Viton and different PFA tubings and connectors (Cole Parmer) were used to make connections in the experimental set up.

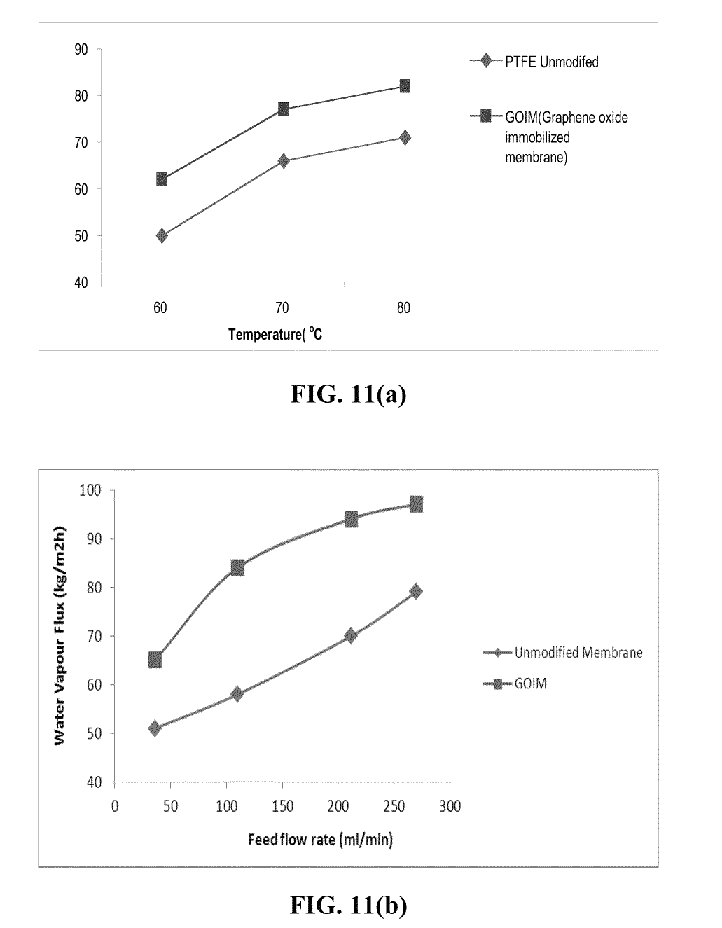

The unmodified PTFE and GOIM membranes were tested for DCMD applications. FIG. 11(a) shows temperature influence on vapor flux of the GOIM and unmodified PTFE membrane at feed flow rate 212 ml min⁻¹ and permeate flow rate 164 ml min⁻¹. The permeate fluxes exhibited an exponential dependence on feed temperature. This could be typically attributed to the fact that temperature difference creates higher vapor pressure difference and thus the water vapor flux rises. Maximum flux reached up to 82 kg/m² h for GOIM membrane at a feed temperature of 80° C. Overall, the GOIM membrane showed consistently higher flux at all temperatures than unmodified PTFE. Notably, at a temperature of 60° C., the GOIM membrane showed a flux of 63 kg/m² h, whereas unmodified PTFE consistently showed a lower flux of only 50 kg/m² h, thereby demonstrating a huge energy saving advantage for the GOIM membrane, where higher pervaporative flux can be achieved at a relatively lower temperature.

Now referring to FIG. 11(b), the effect of feed flow rate on permeate flux is shown. The feed flow rate was varied from 36 to 270 ml min⁻¹ while the permeate side flow rate was fixed at 164 ml min⁻¹ and the permeate side temperature was maintained at 20° C. Water vapor flux increased as the feed velocity increased for both unmodified PTFE membrane and GOIM. However, GOIM showed better performance at all velocities and flux was as high as 84 kg/m² h. In general, higher velocity leads to higher turbulence which results in less temperature polarization and increased driving force across the membrane.

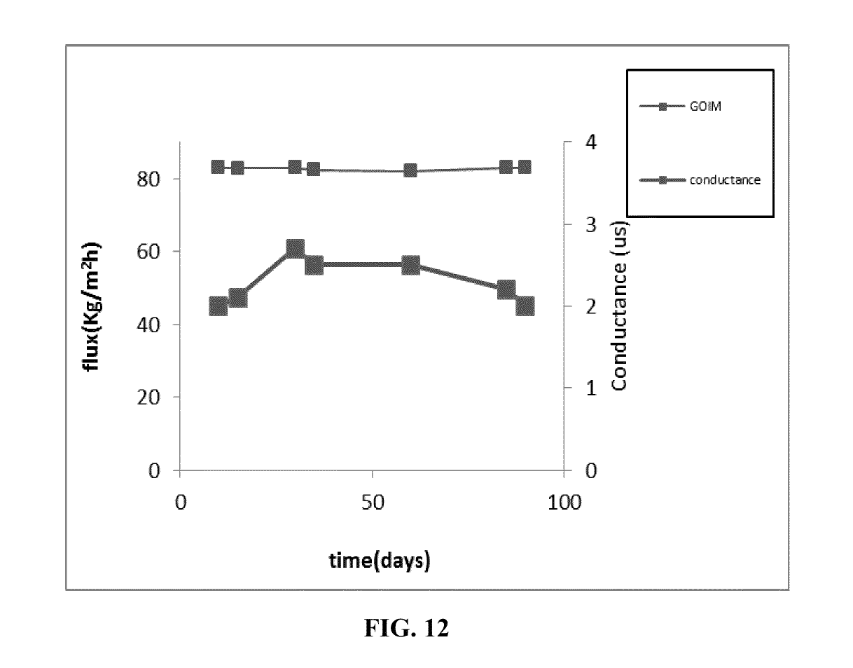

The membranes were also studied at a feed concentration range of 3000-34000 ppm. Water vapor flux in membrane processes tends to decrease with increase in salt concentration, which is primarily due to the decrease in water activity as concentration increases. See, Y. Yun, et al., Direct contact membrane distillation mechanism for high concentration NaCl solutions, Desalination, 188 (2006), pp. 251-262. In the case of the unmodified PTFE membrane, at an elevated feed concentration, a more significant boundary layer develops next to the membrane interface, which reduces driving force of mass transfer. This in turn leads to the decrease in permeate flux in case of unmodified membrane module. On the other hand, the GOIM did not show significant lowering of flux. Even at an elevated concentration of 34000 ppm, the flux was as high as 83 kg/m² h and indicated that the GOIM selectively allowed the passage of water vapor without any potential salt permeation. The long term stability of the membrane is shown in FIG. 12.

Table 7 illustrates that mass transfer coefficients increased with elevated feed temperature for all membrane types. However, it is notable that the overall k was enhanced by the presence of GOs. For GOIM, the resistance to mass transfer was decreased and overall k increased by increasing temperature ranging from 1.17E-06 to 1.48E-06 and was higher than the unmodified Teflon membrane at all temperatures. In general, the presence of the PVDF polymer and GOIM dispersion led to enhanced hydrophobicity and adsorption of vapor within the membrane on the feed side and the hydrophilic character imparted by the functional group on GO ring led to permeation of condensed vapor molecules, leading to a significantly overall higher mass transfer coefficient.

TABLE 7
Variation of Mass Transfer Coefficient at Different Feed Temperatures

Mass transfer
Coefficient (kg/m² · sec · Pa)

| Temperature (° C.) | Unmodified | GOIM |
|---|---|---|
| 60 | 1.01E−06 | 1.17E−06 |
| 70 | 1.07E−06 | 1.32E−06 |
| 80 | 1.11E−06 | 1.48E−06 |

Membrane Distillation with Membranes that Contain Carbon Nanotubes on Both Sides

In accordance with a further embodiment, bilayer fabricated functionalized nanocarbon membranes are disclosed.

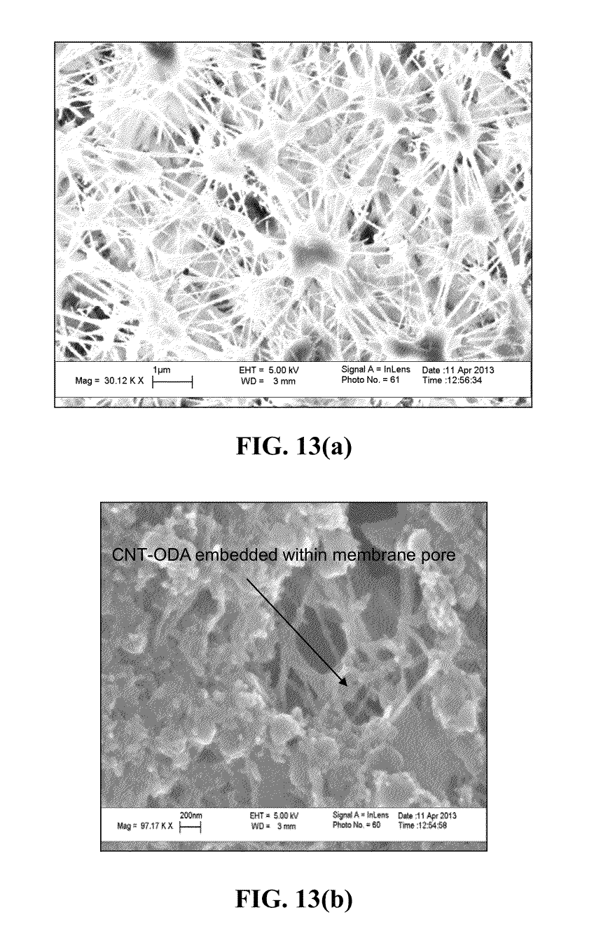

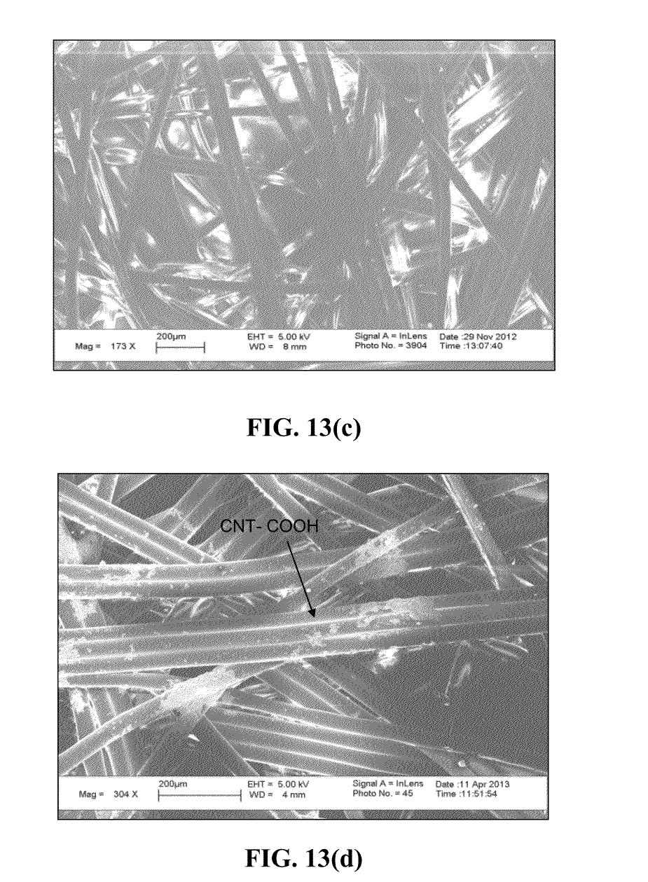

In one embodiment a bilayer fabricated functionalized carbon nanotube membrane was employed in direct contact membrane distillation (DCMD) mode for a desalination application. The functionalized CNT membrane (referred to as NCIM-f) was prepared using a PTFE composite membrane. For the preparation of the NCIM-f, each of 10 mg of MWCNT-ODA and 5 mg of MWCNT-COOH were dispersed in a solution containing 0.005 gm of polytetrafluroethylene (PTFE) powder of 1 μm particle size (Sigma Aldrich) in 10 ml of Fluorinert FC-40 solvent (Sigma Aldirch) by sonicating for three hours. The hydrophobic PTFE-ODA dispersion was then utilized for fabricating the membrane on the feed side and the hydrophilic PTFE-COOH dispersion was utilized for membrane fabrication on the permeate side over the fabric support layer of the membrane. Now referring to FIGS. 13(a)-(d), scanning electron micrographs are depicted of an unmodified PTFE membrane top surface (FIG. 13(a)), a NCIM-ODA membrane top surface (FIG. 13(b)), an unmodified membrane bottom surface (FIG. 13(c)) and a NCIM-COOH membrane bottom surface (FIG. 13(d)).

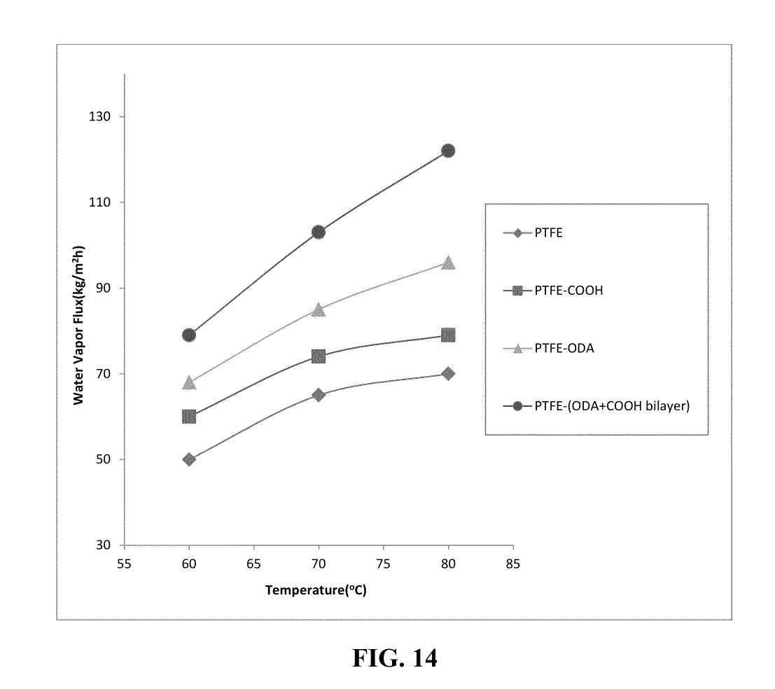

With reference to FIG. 14, the performance of the membrane demonstrated superior flux enhancements over unmodified membrane with water vapor flux reaching as high as 135 kg/m² h with 99.99% salt reduction, operating at 80° C. feed temperature and 25° C. permeate temperature. The membrane modification with functionalized MWCNT-ODA and MWCNT-COOH on both sides of the membrane provided exceedingly hydrophobicity and hydrophilicity on the feed and permeate side respectively, which led to the dramatic enhancement in flux performance.

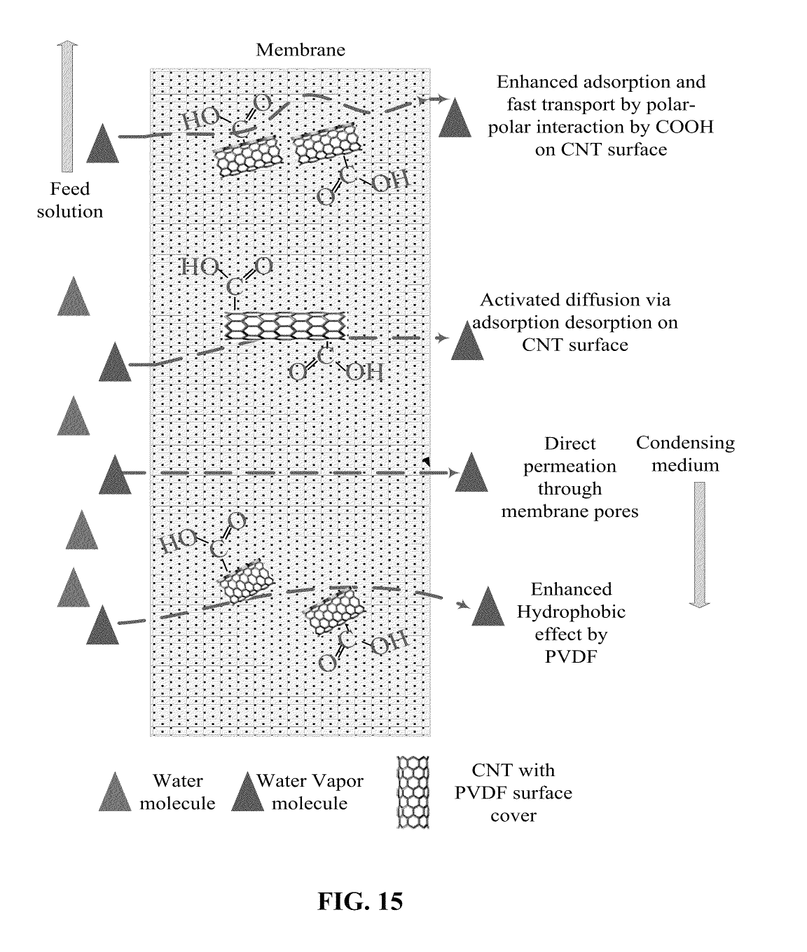

Due to a combination of factors mentioned above, significantly higher flux was observed for NCIM and NCIM-f as compared to conventional membranes. This was attributed to the fact that the nanocarbons including CNTs, graphene and NDs serve as sorbent sites for vapor transport while rejecting the liquid water. With reference to FIG. 15, mechanisms of action are illustrated. Without being confined to a single theory, the carboxylated CNTs are polar and provided higher sorption for the water vapors than unfunctionalized CNTs, thus enhancing flux. Under normal circumstances one would have expected the hydrophilic CNT-COOH to decrease the overall hydrophobicity of the membrane and also interact with the sodium ions. Therefore, one would expect the performance of CNIM-f to be lower than CNIM. However, since PVDF dispersion was used to immobilize the CNT-COOH, the former encapsulated the latter, which prevented water as well as Na ions from reaching the nanotubes. On the other hand, the water vapors that permeated through the PVDF surface were able to partition on the CNT-f and effectively permeate through the membrane.

The mechanisms of enhanced water vapor transport in the presence of DNDs are similar, where DNDs serve as selective sorption sites for water vapors. Since the outer core of the DNDs is graphitic and quite hydrophobic, they decrease pore wetting while enhancing the transport of pure water vapor. This was confirmed by contact angle measurements where unmodified PP had a contact angle of 110° and DNDIM of 119°, which showed that the hydrophobicity of the DNDIM was higher due to inclusion of DNDs which favored the repulsion of the liquid water. Additionally, the DNDs possess a graphitic ring structure with additional —COOH and —OH surface groups which leads to specific interactions with the water vapor molecules leading to enhanced flux. It is also well established that the DNDs have higher surface area, which may lead to enhanced adsorption, which further leads to enhanced flux.

Although the systems and methods of the present disclosure have been described with reference to exemplary embodiments thereof, the present disclosure is not limited thereby. Indeed, the exemplary embodiments are implementations of the disclosed systems and methods are provided for illustrative and non-limitative purposes. Changes, modifications, enhancements and/or refinements to the disclosed systems and methods may be made without departing from the spirit or scope of the present disclosure. Accordingly, such changes, modifications, enhancements and/or refinements are encompassed within the scope of the present invention. All references cited and/or listed herein are incorporated by reference herein in their entireties.

### REFERENCES

(1) A. M. D-Torres, L. G-Rodriguez, Status of solar thermal-driven reverse osmosis desalination, Desalination 216 (2007) 242-251.
(2) A. D. Khawaji, I. K. Kutubkhana, J.-M. Wie, Advances in seawater desalination technologies, Desalination 221 (2008) 47-69.
(3) B. Pefiate, L. G.-Rodriguez, Current trends and future prospects in the design of seawater reverse osmosis desalination technology, Desalination 284 (2012) 1-8.
(4) N. Misdan, W. J. Lau, A. F. Ismail, Seawater Reverse Osmosis (SWRO) desalination by thin-film composite membrane—Current development, challenges and future prospects, Desalination 287 (2012) 228-237.
(5) M. Li. Optimal plant operation of brackish water reverse osmosis (BWRO) desalination, Desalination 293 (2012) 61-68.
(6) S. S. Sablani, M. F. A. Goosen, R. Al-Belushi, M. Wilf, Concentration polarization in ultrafiltration and reverse osmosis: a critical review, Desalination 141 (2001) 269-289.
(7) P. Peng, A. G. Fane, X. Li, Desalination by membrane distillation adopting a hydrophilic membrane, Desalination 173(2005) 45-54.
(8) B. R. Babu, N. K. Rastogi, K. S. Raghavarao, Concentration and temperature polarization effects during osmotic membrane distillation, J Membr. Sci. 322 (2008) 146-153.
(9) College of Engineering, University of Texas at El Paso, Desalination Water Purification Research and Development Program Report No. 81 2004.
(10) M. M. Teoh, T.-S. Chung, Y. S. Yeo, Dual-layer PVDF/PTFE composite hollow fibers with a thin macrovoid-free selective layer for water production via membrane distillation Chem. Engr. J. 171 (2011) 684-691.
(11) D. Hou, J. Wang, X. Sun, Z. Ji, Z. Luan, Preparation and properties of PVDF composite hollow fiber membranes for desalination through direct contact membrane distillation, J. of Membr. Sci. 4051 (2012) 185-200.
(12) C. H. Cho, K. Y. Oh, S. K. Kim, J. G. Yeo, P. Sharma, Pervaporative seawater desalination using NaA zeolite membrane: Mechanisms of high water flux and high salt rejection, Jr. Membr. Sci. 371 (2011) 226-238.
(13) J. A. Prince, G. Singh, D. Rana, T. Matsuura, V. Anbharasi, T. S. Shanmugasundaram, Preparation and characterization of highly hydrophobic poly(vinylidene fluoride)—Clay nanocomposite nanofiber membranes (PVDF—clay NNMs) for desalination using direct contact membrane distillation, J. Membr. Sci. 397(2012) 80-86.
(14) S. Khemakhem, R. B. Amar, Modification of Tunisian clay membrane surface by silane grafting: Application for desalination with Air Gap Membrane Distillation process, Colloids and Surfaces A: Physicochemical and Engineering Aspects. 387 (2011) 79-85.
(15) H. Fang, J. F. Gao, H. T. Wang, C. S. Chen, Hydrophobic porous alumina hollow fiber for water desalination via membrane distillation process, J. Membr. Sci. 403(2012) 41-46.
(16) K. Gethard, O. S. Khow, S. Mitra, Water desalination using carbon-nanotube enhanced membrane distillation. Appl. Mater., 3 (2011), pp. 110-114.
(17) C. Desai, S. Mitra, Microwave induced carboxylation of nanodiamonds, Diam. Relat. Mater., 34 (2013), pp. 65-69.
(18) J. Phattaranawik, R. Jiraratananon, Direct contact membrane distillation: effect of mass transfer on heat transfer. J. Membr. Sci., 188 (2001), pp. 137-143.
(19) V. Georgakilas, M. Otyepka, A. B. Bourlinos, V. Chandra, N. Kim, K. C. Kemp, P. Hobza, R. Zboril, and K. S. Kim, Functionalization of Graphene: Covalent and Non-Covalent Approaches, Derivatives and Applications, Chem. Rev., 112 (2012), pp 6156-6214.
(20) F. Bonaccorso, A. Lombardo, T. Hasana, Z. Sun, L. Colombo, A. C. Ferrari, Production and processing of graphene and 2d crystals. Materials Today, 15 (2012), pp. 564-589.
(21) Y. Yun, R. Ma, W. Zhang, A. G. Fane, and J. Li, Direct contact membrane distillation mechanism for high concentration NaCl solutions, Desalination, 188 (2006), pp. 251-262.

What is claimed is:

1. A membrane comprising a nanocarbon immobilized on or in a pore of the membrane, the nanocarbon comprising a carbon nanotube comprising one or more functional groups selected from a carboxylic acid, a polymer, a metal, a metal oxide, an amine, an amide, a nitro, a hydroxyl, polyaminobenzene sulfonic acid, propyl amine, alkyl amine, octadecylamine, and/or sulphonic acid.

2. The membrane of claim 1 wherein the functional group is carboxylic acid or an alkyl amine.

3. The membrane of claim 1 comprising a hollow fiber membrane.

4. The membrane of claim 1 comprising a flat membrane.

5. The membrane of claim 1 comprising a bilayer membrane.

6. The membrane of claim 5 comprising a first layer comprising a nanocarbon comprising one or more functional groups selected from a carboxylic acid, a polymer, a metal, a metal oxide, an amine, an amide, a nitro, a hydroxyl, polyaminobenzene sulfonic acid, propyl amine, alkyl amine, octadecylamine, and/or sulphonic acid, and a second layer comprising a membrane.

7. The membrane according to claim 6 wherein the second layer membrane comprises a carbon nanotube immobilized on or in a pore of the second layer membrane, the carbon nanotube comprising one or more functional groups selected from a carboxylic acid, a polymer, a metal, a metal oxide, an amine, an amide, a nitro, a hydroxyl, polyaminobenzene sulfonic acid, propyl amine, alkyl amine, octadecylamine, and/or sulphonic acid, the carbon nanotube immobilized in a pore or surface of a membrane.

8. A membrane distillation apparatus comprising a membrane according to claim 1.

9. The membrane distillation apparatus of claim 8 wherein the apparatus is a direct contact membrane distillation apparatus, an air gap membrane distillation apparatus, a sweep gas membrane distillation apparatus, or a vacuum distillation apparatus

10. A membrane distillation desalination apparatus comprising a membrane according to claim 1.

11. A membrane comprising a nanodiamond immobilized on or in a pore of the membrane, wherein the nanodiamond comprises either no functional group or one or more functional groups selected from a carboxylic acid, a polymer, a metal, a metal oxide, an amine, an amide, a nitro, a hydroxyl, polyaminobenzene sulfonic acid, propyl amine, alkyl amine, octadecylamine, and/or sulphonic acid.

12. A membrane distillation apparatus comprising a membrane according to claim 11.

13. The membrane distillation apparatus of claim 12 wherein the apparatus is a direct contact membrane distillation apparatus, an air gap membrane distillation apparatus, a sweep gas membrane distillation apparatus, or a vacuum distillation apparatus.

14. A membrane distillation desalination apparatus comprising a membrane according to claim 11.

15. A membrane comprising graphene oxide immobilized on or in a pore of the membrane, wherein the graphene may comprise no functional group or one or more functional groups selected from carboxylic acid, a polymer, a metal, a metal oxide, an amine, an amide, a nitro, a hydroxyl, polyaminobenzene sulfonic acid, propyl amine, alkyl amine, octadecylamine, and/or sulphonic acid.

16. A membrane distillation apparatus comprising a membrane according to claim 15.

17. The membrane distillation apparatus of claim 16 wherein the apparatus is a direct contact membrane distillation apparatus, an air gap membrane distillation apparatus, a sweep gas membrane distillation apparatus, or a vacuum distillation apparatus.

18. A membrane distillation desalination apparatus comprising a membrane according to claim 15.

19. A membrane comprising at least two layers, wherein a first layer comprises a membrane comprising a nanocarbon immobilized on or in a pore of the membrane, wherein the immobilized nanocarbon is selected from the group consisting of a carbon nanotube, a nanodiamond and graphene oxide, wherein when the immobilized nanocarbon is a carbon nanotube, the immobilized nanocarbon comprises one or more functional groups selected from carboxylic acid, a polymer, a metal, a metal oxide, an amine, an amide, a nitro, a hydroxyl, polyaminobenzene sulfonic acid, propyl amine, alkyl amine, octadecylamine, and/or sulphonic acid;
and a second layer comprising a second layer membrane.

20. The membrane of claim 19, wherein the second membrane layer comprises a nanocarbon immobilized on or in the pores of the membrane, wherein the immobilized nanocarbon is selected from the group consisting of a carbon nanotube, a nanodiamond, and graphene oxide, wherein when the immobilized nanocarbon is a carbon nanotube, the immobilized nanocarbon comprises one or more functional groups selected from carboxylic acid, a polymer, a metal, a metal oxide, an amine, an amide, a nitro, a hydroxyl, polyaminobenzene sulfonic acid, propyl amine, alkyl amine, octadecylamine, and/or sulphonic acid.

21. A membrane distillation apparatus comprising a membrane according to claim 19.

22. The membrane distillation apparatus of claim 22 wherein the apparatus is a direct contact membrane distillation apparatus, an air gap membrane distillation apparatus, a sweep gas membrane distillation apparatus, or a vacuum distillation apparatus.

23. A membrane distillation desalination apparatus comprising a membrane according to claim 19.

24. A membrane comprising a functionalized nanocarbon immobilized on or in a pore of the membrane.

25. The membrane according to claim 24, the functionalized nanocarbon selected from the group consisting of a carbon nanotube, a nanodiamond, and graphene oxide.

26. A membrane distillation apparatus comprising a membrane according to claim 24.

27. The membrane distillation apparatus of claim 26 wherein the apparatus is a direct contact membrane distillation apparatus, an air gap membrane distillation apparatus, a sweep gas membrane distillation apparatus, or a vacuum distillation apparatus.

28. A membrane distillation desalination apparatus comprising a membrane according to claim 24.
